(19) United States
(12) Patent Application Publication
(10) Pub. No.: US 2009/0159834 A1
(43) Pub. Date: Jun. 25, 2009

(54) NANOSCALE SUPERPARAMAGNETIC POLY(METH)ACRYLATE POLYMERS

(75) Inventors: Sebastian Roos, Kelkheim (DE); Gerd Löhden, Essen (DE); Jan Hendrik Schattka, Hanau (DE); Manfred Braum, Mainz (DE); Markus Pridöhl, Gross-Krotzenburg (DE); Guido Zimmermann, Brühl (DE); Andreas Hüther, Alzenau (DE)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK ROEHM GMBH, DARMSTADT (DE)

(21) Appl. No.: 12/279,276

(22) PCT Filed: Nov. 21, 2006
(86) PCT No.: PCT/EP06/68708

§ 371 Date: Oct. 13, 2008

(30) Foreign Application Priority Data
Feb. 16, 2006 (DE) 102006007564.1

(51) Int. Cl. H01F 1/26; B05D 5/10

(52) U.S. Cl. 252/62.54; 427/127

(57) ABSTRACT

The invention relates to hybrid materials comprising polymers which envelop nanoscale, superparamagnetic, ferromagnetic, ferrimagnetic or paramagnetic powders, to a process for producing these materials and to their use.

The invention relates to hybrid materials comprising polymers which envelop nanoscale, superparamagnetic, ferromagnetic, ferrimagnetic or paramagnetic powders, to a method of producing these materials, and to their use.

### PRIOR ART

In DE 100 37 883 (Henkel) 0.1% by weight-70% by weight of magnetic particles are used in order to heat a substrate by means of microwave radiation. The substrate used is an adhesive, which sets as a result of the heating. The heating of the adhesive can also be utilized to soften the adhesive. Interaction between particles and polymer is not described.

DE 100 40 325 (Henkel) describes a method involving applying a microwave-activable primer and a hot-melt adhesive to substrates and using microwaves to carry out heating and bonding.

DE 102 58 951 (Sus Tech GmbH) describes an adhesive sheet comprising a compound of ferrite particles (surface-modified with oleic acid) and PE, PP, EVA and copolymers. The ferrite particles may also have been modified with silanes, quaternary ammonium compounds and saturated/unsaturated fatty acids and salts of strong inorganic acids.

DE 199 24 138 (Henkel) describes an adhesive composition with nanoscale particles.

EP 498 998 describes a method of heating a polymer by microwaves, where ferromagnetic particles are dispersed in the polymer matrix and microwaves are irradiated. The ferromagnetic particles are merely dispersed in the polymer matrix.

WO 01/28 771 (Loctite) describes a curable composition comprising 10% by weight-40% by weight of particles which can absorb microwaves, a curable component, and a curing agent. The components are merely mixed.

WO 03/04 2315 (Degussa) discloses an adhesive composition for producing thermosets, comprising a polymer blend and crosslinker particles, the crosslinker particles being composed of fillers, which are ferromagnetic, ferrimagnetic, superparamagnetic or paramagnetic, and crosslinker units bonded chemically to the filler particles. The filler particles may also have been surface-modified. The filler particles may have a core/shell structure. The adhesive association obtained can be parted again by heating it to a temperature higher than the ceiling temperature or to a temperature sufficient to break the chemical bonds of the thermally labile groups of the surface-modified filler particles.

DE-A-101 63 399 describes a nanoparticulate preparation which has a coherent phase and, dispersed therein, at least one particulate phase of superparamagnetic, nanoscale particles. The particles have a volume-averaged particle diameter in the range from 2 to 100 nm and contain at least one mixed metal oxide of the general formula MIIMIIIO₄, in which MII stands for a first metal component which comprises at least two different, divalent metals, and MIII stands for a further metal component which comprises at least one trivalent metal. The coherent phase may be composed of water, an organic solvent, a polymerizable monomer, a polymerizable monomer mixture, a polymer and mixtures. Preparations in the form of an adhesive composition are preferred.

It is an object of the invention to provide a material that comprises nanoscale superparamagnetic, ferromagnetic, ferrimagnetic or paramagnetic particles.

This object is achieved through the provision of hybrid material comprising nanoscale superparamagnetic, ferromagnetic, ferrimagnetic or paramagnetic particles enveloped by polymers, in particular by poly(meth)-acrylates.

The object is also achieved by a method of miniemulsion polymerization. This method, in contrast to the methods of conventional emulsion polymerization, enables the preparation of the core (inorganic particle)/shell (polymer) particles. The object is achieved by a method of Claim 16. The cores can be enveloped by one shell, but also by two or more shells, or by a shell with gradients. The shells may have alike or different polymer compositions, or within one shell the polymer composition may vary (gradients).

Through the encasing of the nanoscale, superparamagnetic, ferromagnetic, ferrimagnetic or paramagnetic particles with the polymer, improved interaction of the particle with the polymer envelope is achieved and it is therefore possible to achieve the heating of the adhesive with fewer nanoscale, superparamagnetic, ferromagnetic, ferrimagnetic or paramagnetic particles than are needed in the prior art.

The heating may take place by means of conventional forms of energy, but preferably by means of inductive energy.

With the hybrid materials of the invention it is possible to prepare 1-stage and 2-stage adhesives. The 2-stage adhesives with the hybrid material of the invention are notable for a simple adhesive-bonding effect (preliminary adhesive bonding, fixing) and an ultimate adhesive bonding through introduction of high energy, in one material.

The nanoscale, superparamagnetic, ferromagnetic, ferrimagnetic or paramagnetic particles are emulsified, without prior activation or preliminary coating, in a system made up of one or more monomers, water and an inert solvent, where appropriate with the assistance of an emulsifier and/or of a hydrophobic agent, and the polymerization is subsequently initiated by the usual techniques.

The nanoscale, superparamagnetic, ferromagnetic, ferrimagnetic or paramagnetic particles may be enclosed in a core/shell structure with one or more shells of polymers or polymer blends.

In a first step a first shell of the core/shell system is applied to the core by means of miniemulsion polymerization. Any further shells are formed in situ by metered addition of the monomer stream.

Monomers used are preferably mixtures of (meth)acrylates.

Polymethyl methacrylates are generally obtained by free-radical polymerization of mixtures comprising methyl methacrylate. In general these mixtures contain at least 40% by weight, preferably at least 60% by weight and with particular preference at least 80% by weight, based on the weight of the monomers, of methyl methacrylate. In addition these mixtures for the preparation of polymethyl methacrylates may comprise further (meth)acrylates which are copolymerizable with methyl methacrylate. The expression (meth)acrylates here denotes not only methacrylate, such as methyl methacrylate, ethyl methacrylate, etc., for example, but also acrylate, such as methyl acrylate, ethyl acrylate, etc., for example, and additionally mixtures of both.

These monomers are widely known. They include, among others, (meth)acrylates which derive from saturated alcohols, such as methyl acrylate, ethyl (meth)-acrylate, propyl (meth)acrylate, n-butyl (meth)acrylate, tert-butyl (meth)acrylate, pentyl (meth)acrylate and 2-ethylhexyl (meth)acrylate, for example; (meth)-acrylates which derive from unsaturated alcohols, such as oleyl (meth)acrylate, 2-propynyl (meth)acrylate, allyl (meth)acrylate, vinyl (meth)acrylate, for example; aryl (meth)acrylates, such as benzyl (meth)acrylate or phenyl (meth)acrylate, it being possible for the aryl radicals in each case to be unsubstituted or to be substituted up to four times; cycloalkyl (meth)-acrylates, such as 3-vinylcyclohexyl (meth)acrylate, bornyl (meth)acrylate; hydroxylalkyl (meth)acrylates, such as 3-hydroxypropyl (meth)acrylate, 3,4-dihydroxy-butyl (meth)acrylate, 2-hydroxyethyl (meth)acrylate, 2-hydroxypropyl (meth)acrylate; glycol di(meth)-acrylates, such as 1,4-butanediol (meth)acrylate, (meth)acrylates of ether alcohols, such as tetra-hydrofurfuryl (meth)acrylate, vinyloxyethoxyethyl (meth)acrylate; amides and nitriles of (meth)acrylic acid, such as N-(3-dimethylaminopropyl)(meth)acryl-amide, N-(diethylphosphono)(meth)acrylamide, 1-meth-acryloylamido-2-methyl-2-propanol; sulphur-containing methacrylates, such as ethylsulphinylethyl (meth)-acrylate, 4-thiocyanatobutyl (meth)acrylate, ethyl-sulphonylethyl (meth)acrylate, thiocyanatomethyl (meth)acrylate, methylsulphinylmethyl (meth)acrylate, bis((meth)acryloyloxyethyl) sulphide; polyfunctional (meth)acrylates, such as trimethylolpropane tri(meth)-acrylate.

Besides the (meth)acrylates set out above, the compositions for polymerization may also contain further unsaturated monomers which are copolymerizable with methyl methacrylate and with the aforementioned (meth)acrylates. Such monomers include, among others, 1-alkenes, such as hex-1-ene, hept-1-ene; branched alkenes, such as vinylcyclohexane, 3,3-dimethyl-1-propene, 3-methyl-1-diisobutylene, 4-methylpent-1-ene, for example; acrylonitrile; vinyl esters, such as vinyl acetate; styrene, substituted styrenes having an alkyl substituent in the side chain, such as [alpha]-methylstyrene and [alpha]-ethylstyrene, for example, substituted styrenes with an alkyl substituent on the ring, such as vinyltoluene and p-methylstyrene, halogenated styrenes, such as monochlorostyrenes, dichlorostyrenes, tribromostyrenes and tetrabromo-styrenes, for example; heterocyclic vinyl compounds, such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinyl-pyrrolidone, 2-vinylpyrrolidone, N-vinylpyrrolidine, 3-vinylpyrrolidine, N-vinylcaprolactam, N-vinylbutyro-lactam, vinyloxolane, vinylfuran, vinylthiophene, vinylthiolane, vinylthiazoles and hydrogenated vinyl-thiazoles, vinyloxazoles and hydrogenated vinyl-oxazoles; vinyl and isoprenyl ethers; maleic acid derivatives, such as maleic anhydride, methylmaleic anhydride, maleimide, methylmaleimide, for example; and dienes, such as divinylbenzene, for example.

In general these comonomers are used in an amount of 0% to 60% by weight, preferably 0% to 40% by weight and with particular preference 0% to 20% by weight, based on the weight of the monomers, it being possible for the compounds to be used individually or as a mixture.

The polymerization is generally initiated using known free-radical initiators. The preferred initiators include, among others, the azo initiators widely known in the art, such as AIBN and 1,1-azobiscyclohexane-carbonitrile, water-soluble free-radical initiators, such as peroxosulphates or hydrogen peroxide, for example, and also peroxy compounds, such as methyl ethyl ketone peroxide, acetylacetone peroxide, dilauryl peroxide, tert-butyl per-2-ethylhexanoate, ketone peroxide, methyl isobutyl ketone peroxide, cyclohexanone peroxide, dibenzoyl peroxide, tert-butyl peroxy-benzoate, tert-butyl peroxyisopropyl carbonate, 2,5-bis(2-ethylhexanoylperoxy)-2,5-dimethylhexane, tert-butyl peroxy-2-ethylhexanoate, tert-butyl peroxy-3,5,5-trimethylhexanoate, dicumyl peroxide, 1,1-bis-(tert-butylperoxy)cyclohexane, 1,1-bis(tert-butyl-peroxy)-3,3,5-trimethylcyclohexane, cumyl hydroperoxide, tert-butyl hydroperoxide, bis(4-tert-butylcyclo-hexyl) peroxydicarbonate, mixtures of two or more of the aforementioned compounds with one another, and also mixtures of the aforementioned compounds with unstated compounds which can likewise form free radicals.

These compounds are used frequently in an amount of 0.01% to 10% by weight, preferably of 0.1% to 3% by weight, based on the weight of the monomers. In this context it is possible to use different poly(meth)-acrylates which differ for example in molecular weight or in the monomer composition.

Hydrophobic agents as well can be added to the hybrid material. Suitable examples include hydrophobes from the group of the hexadecanes, tetraethylsilanes, oligo-styrenes, polyesters or hexafluorobenzenes. Particular preference is given to copolymerizable hydrophobes, since they do not exude in the course of subsequent use.

Particular preference is given to (meth)acrylates which derive from saturated alcohols having 6-24 C atoms, it being possible for the alcohol residue to be linear or branched.

Thus, for example, one monomer composition comprises ethylenically unsaturated monomers of formula (I)

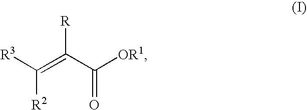

in which R is hydrogen or methyl, R¹ is a linear or branched alkyl radical having 6 to 40 carbon atoms, preferably 6 to 24 carbon atoms, R² and R³ independently are hydrogen or a group of the formula —COOR′, where R′ represents hydrogen or a linear or branched alkyl radical having 6 to 40 carbon atoms.

The ester compounds with long-chain alcohol residue can be obtained for example by reacting (meth)acrylates, fumarates, maleates and/or the corresponding acids with long-chain fatty alcohols, the product generally comprising a mixture of esters, such as, for example, (meth)acrylates with alcohol residues whose chains differ in length. These fatty alcohols include, among others, Oxo Alcohol® 7911 and Oxo Alcohol® 7900, Oxo Alcohol® 1100 from Monsanto; Alphanol® 79 from ICI; Nafol® 1620, Alfol® 610 and Alfol® 810 from Condea; Epal® 610 and Epal® 810 from Ethyl Corporation; Linevol® 79, Linevol® 911 and Dobanol® 25L from Shell AG; Lial 125 from Augusta® Milan; Dehydad® and Lorol® from Henkel KGaA, and Linopol® 7-11 and Acropol® 91 Ugine Kuhlmann.

The abovementioned ethylenically unsaturated monomers can be used individually or as mixtures. In preferred embodiments of the method of the invention at least 50 percent by weight of the monomers, preferably at least 60 percent by weight of the monomers, with particular preference more than 80% by weight of the monomers, based on the total weight of the ethylenically unsaturated monomers, are (meth)acrylates.

Preference is given, moreover, to monomer compositions which contain at least 60 percent by weight, with particular preference more than 80% by weight, of (meth)acrylates having alkyl or heteroalkyl chains that contain at least 6 carbon atoms, based on the total weight of the ethylenically unsaturated monomers.

Besides the (meth)acrylates preference is also given to maleates and fumarates which additionally have long-chain alcohol residues.

By way of example it is possible to use hydrophobes which are derived from the group of the alkyl (meth)acrylates having 10 to 30 carbon atoms in the alcohol group, especially undecyl (meth)acrylate, 5-methylundecyl (meth)acrylate, dodecyl (meth)acrylate, 2-methyldodecyl (meth)acrylate, tridecyl (meth)-acrylate, 5-methyltridecyl (meth)acrylate, tetradecyl (meth)acrylate, pentadecyl (meth)acrylate, hexadecyl (meth)acrylate, 2-methylhexadecyl (meth)acrylate, heptadecyl (meth)acrylate, 5-isopropylheptadecyl (meth)acrylate, 4-tert-butyloctadecyl (meth)acrylate, 5-ethyloctadecyl (meth)acrylate, 3-isopropyloctadecyl (meth)acrylate, octadecyl (meth)acrylate, nonadecyl (meth)acrylate, eicosyl (meth)acrylate, cetyleicosyl (meth)acrylate, stearyleicosyl (meth)acrylate, docosyl (meth)acrylate, eicosyltetratriacontyl (meth)acrylate, lauryl (meth)acrylates, stearyl (meth)acrylates, behenyl (meth)acrylates and/or methacrylic esters and mixtures thereof.

In order to control the molecular weight of the polymers it is possible to carry out the polymerization in the presence if desired of regulators. Examples of suitable regulators include aldehydes such as formaldehyde, acetaldehyde, propionaldehyde, n-butyraldehyde and isobutylaldehyde, formic acid, ammonium formate, hydroxylammonium sulphate and hydroxylammonium phosphate. Additionally it is possible to use regulators which contain sulphur in organically bonded form, such as organic compounds containing SH groups, such as thioglycolacetic acid, mercaptopropionic acid, mercaptoethanol, mercaptopropanol, mercaptobutanol, mercaptohexanol, dodecyl mercaptan and tert-dodecyl mercaptan. As regulators it is possible in addition to use salts of hydrazine such as hydrazinium sulphate. The amounts of regulator, based on the monomers to be polymerized, are 0% to 5%, preferably 0.05% to 0.3% by weight.

The cores of the invention, the nanoscale, superparamagnetic, ferromagnetic, ferrimagnetic or paramagnetic particles, are composed of a matrix and a domain. The particles are composed of magnetic metal oxide domains having a diameter of 2 to 100 nm in a non-magnetic metal oxide matrix or metal dioxide matrix. The magnetic metal oxide domains may be selected from the group of the ferrites, with particular preference from the group of the iron oxides. They may be surrounded in turn, completely or partially, by a non-magnetic matrix, from the group for example of the silicon oxides. The nanoscale, superparamagnetic, ferromagnetic, ferrimagnetic or paramagnetic particles are in the form of powder. The powder may be composed of aggregated primary particles. By aggregated in the sense of the invention are meant three-dimensional structures of commerged primary particles. Two or more aggregates may join to form agglomerates. These agglomerates can easily be separated again. In contrast, breaking down the aggregates into the primary particles is generally not possible.

The aggregate diameter of the superparamagnetic powder may preferably be greater than 100 nm and less than 1 μm. With preference the aggregates of the superparamagnetic, ferromagnetic, ferrimagnetic or paramagnetic powder may have a diameter at least in one spatial direction of not more than 250 nm.

By domains are meant regions within a matrix that are spatially separate from one another. The domains of the superparamagnetic, ferromagnetic, ferrimagnetic or paramagnetic powder have a diameter of between 2 and 100 nm.

The domains may also contain non-magnetic regions which make no contribution to the magnetic properties of the powder.

In addition it is also possible for there to be magnetic domains which by virtue of their size do not exhibit superparamagnetism, and which induce remanence. This leads to an increase in the volume-specific saturation magnetization. The proportion of these domains in comparison to the number of superparamagnetic, ferromagnetic, ferrimagnetic or paramagnetic domains, however, is low. In accordance with the present invention the number of superparamagnetic, ferromagnetic, ferrimagnetic or paramagnetic domains present in the superparamagnetic, ferromagnetic, ferrimagnetic or paramagnetic powder is such as to allow the preparation of the invention to be heated by means of a magnetic or electromagnetic alternating field. The domains of the superparamagnetic, ferromagnetic, ferrimagnetic or paramagnetic powder may be surrounded completely or only partially by the encompassing inorganic matrix. Partially surrounded means that individual domains may protrude from the surface of an aggregate.

The domains may contain one or more metal oxides.

The magnetic domains may contain preferably the oxides of iron, cobalt, nickel, chromium, europium, yttrium, samarium or gadolinium. In these domains the metal oxides may be present in a uniform modification or in different modifications.

One particularly preferred magnetic domain is iron oxide in the form of gamma-Fe₂O₃ (γ-Fe₂O₃), Fe₃O₄, mixtures of gamma-Fe₂O₃ (γ-Fe₂O₃) and/or Fe₃O₄.

The magnetic domains may further be present in the form of a mixed oxide of at least two metals, with the metal components iron, cobalt, nickel, tin, zinc, cadmium, magnesium, manganese, copper, barium, magnesium, lithium or yttrium.

The magnetic domains may additionally be substances with the general formula MIIFe₂O₄, in which MII stands for a metal component which comprises at least two different, divalent metals. With preference one of the divalent metals may be manganese, zinc, magnesium, cobalt, copper, cadmium or nickel.

Additionally it is possible for the magnetic domains to be composed of ternary systems of the general formula (Ma1-x-y MbxFey)IIFe₂IIIO₄, where Ma and Mb, respectively, are the metals manganese, cobalt, nickel, zinc, copper, magnesium, barium, yttrium, tin, lithium, cadmium, magnesium, calcium, strontium, titanium, chromium, vanadium, niobium, molybdenum, with x=0.05 to 0.95, y=0 to 0.95 and x+y≦1.

Particular preference may be given to ZnFe₂O₄, MnFe₂O₄, Mn_{0.6}Fe_{0.4}Fe₂O₄, Mn_{0.5}Zn_{0.5}Fe₂O₄, Zn_{0.1}Fe_{1.9}O₄, Zn_{0.2}Fe_{1.8}O₄, Zn_{0.3}Fe_{1.7}O₄, Zn_{0.4}Fe_{1.6}O₄ or Mn_{0.39}Zn_{0.27}Fe_{2.34}O₄, MgFe₂O₃, Mg_{1.2}Mn_{0.2}Fe_{1.6}O₄, Mg_{1.4}Mn_{0.4}Fe_{1.2}O₄, Mg_{1.6}Mn_{0.6}Fe_{0.8}O₄, Mg_{1.8}Mn_{0.8}Fe_{0.4}O₄.

The choice of the metal oxide of the non-magnetic matrix is not further restricted. Preference may be given to the oxides of titanium, zirconium, zinc, aluminium, silicon, cerium or tin.

For the purposes of the invention the metal oxides also include metal dioxides, such as silicon dioxide, for example.

In addition it is possible for the matrix and/or the domains to be in amorphous and/or crystalline form.

The proportion of the magnetic domains in the powder is not restricted provided that there is spatial separation of matrix and domains. The fraction of the magnetic domains in the superparamagnetic, ferromagnetic, ferrimagnetic or paramagnetic powder can be preferably 10% to 100% by weight.

Suitable superparamagnetic powders are described for example in EP-A-1284485 and also in DE 10317067, hereby incorporated in their entirety by reference.

The preparation of the invention may preferably have a fraction of superparamagnetic powder in a range from 0.01% to 60% by weight, preferably a range from 0.05% to 50% by weight and with very particular preference in a range from 0.1% to 10% by weight.

The powder can be prepared via different preparation methods. For example, a silicon chloride can be evaporated at elevated temperature and fed together with a carrier gas into the mixing zone of a burner. Additionally, an aerosol, obtained from an aqueous iron chloride solution, is introduced into the mixing zone within the burner by means of a carrier gas. There the homogeneously mixed gas/aerosol mixture burns at an adiabatic combustion temperature. After the reaction, in a known way, the reaction gases and the resultant powder are cooled and separated by means of a filter from the waste-gas stream. In a further step, by treatment with steam-containing nitrogen, residues of hydrochloric acid still adhering are removed from the powder.

The table below compiles, by way of example, some physicochemical data for superparamagnetic powders.

TABLE 1
Physicochemical values of superparamagnetic powders

| Powder | | P-1 | P-2 | P-3 | P-4 |
|---|---|---|---|---|---|
| Matrix/domain | | SiO₂/ | SiO₂/ | SiO₂/ | SiO₂/ |
| | | Fe₂O₃* | Fe₂O₃* | Fe₂O₃* | Fe₂O₃*, |
| | | | | | MnO, MgO** |
| Domain | wt. % | 50 | 85 | 50 | 50 |
| fraction | | | | | |
| BET surface | m²/g | 43 | 44 | 146 | 41 |
| area | | | | | |
| Curie | ° C. | 620 | 620 | 620 | 330 |
| temperature | | | | | |
| Saturation | Am²/kg | 29.7 | 54.2 | 17.0 | 10.8 |
| magnetization | | | | | |

Calculated on Fe₂O₃; domains contain Fe₂O₃ and Fe₃O₄; Fe₂O₃ 33% by weight

The resulting superparamagnetic, ferromagnetic, ferrimagnetic or paramagnetic powders are processed further with a miniemulsion polymerization process to give the hybrid materials of the invention.

The miniemulsion polymerization can be carried out as follows:

a)

In a first step the nanoscale powder is dispersed in the monomers or the monomer mixture or in water.

b)

In the second step a monomer or a monomer mixture is dispersed with hydrophobic agents and emulsifier in water.

c)

In the third step the dispersions from a) and b) are dispersed with the aid of an emulsifier by means of ultrasound, membrane, rotor/stator system, stirrer and/or or high pressure.

d)

The polymerization of the dispersion from c) is initiated thermally.

The fraction of the superparamagnetic, ferromagnetic, ferrimagnetic or paramagnetic powders in polymers can be between 1-99% by weight.

The hybrid materials produced in this way are used preferably in adhesives. Preference is given to a core (hybrid material)/shell(s) (polymers) construction. With preference a first (inner) shell comprises polymers or polymer mixtures which are gellable at room temperature in plasticizers or plasticizer-containing adhesives or epoxy adhesives. At higher temperatures, moreover, these polymers enter into crosslinking reactions with the plasticizers. Particularly suitable for this purpose are monomers from the group of the (meth)acrylates and imidazoles, preferably vinyl-imidazoles. There may also be auxiliaries and additives present, such as emulsifiers and hydrophobic agents, for example.

In the case of a multi-shell construction the outer shell is constructed preferably from a polymer or polymer blend which is not gellable at room temperature in the matrix (adhesive, for example) but is gellable in the matrix at an elevated temperature. With preference an outer shell is composed of polymethyl methacrylate or of mixtures with vinylimidazole.

These adhesives are used in automotive construction, aircraft construction, shipbuilding, rail-vehicle construction and space-travel technology.

The examples given below are given for better illustration of the present invention, but are not such as to restrict the invention to the features disclosed herein.

### EXAMPLES

### Implementation of the Coat-Applying Miniemulsion Polymerization

### Example 1

In a glass beaker 7.13 g of methyl methacrylate, 7.13 g of butyl methacrylate, 0.75 g of 2-dimethylaminoethyl methacrylate, 0.6 g of hexadecane and 1.5 g of MagSilica (SiO₂/Fe₂O₃) are homogenized using an Ultraturrax for 1 minute and then homogenized with ultrasound for 1 minute. In a second glass beaker 5.0 g of Texapon in 15% form (Cognis, Germany) and 80 g of water are mixed by shaking. The solution from the first glass beaker is introduced into the second and the combined solution is ultrasonicated with ice cooling for 4 minutes. As an initiator, 0.22 g of tert-butyl per-2-ethylhexanoate is introduced, and the solution is poured into a round-bottomed flask and heated at 80° C. The polymerization time is approximately 3 hours.

The UP 200 S ultrasound processor (Dr. Hielscher GmbH, Teltow) used in the experiments has an effective output of 150 W, which can be regulated steplessly from 20% to 100%, a frequency of 24 kHz and a maximum energy density of 12 to 600 W/cm² according to Sonotrode (here, Sonotrode S14D, diameter 14 mm, length 100 mm). For the experiments the effective output was set at 100%.

### Example 2

In a glass beaker 7.43 g of methyl methacrylate, 7.13 g of butyl methacrylate, 0.45 g of 2-methacryloyloxyethyl phosphate, 0.6 g of hexadecane and 1.5 g of MagSilica (SiO₂/Fe₂O₃) are homogenized using an Ultraturrax for 1 minute and then homogenized with ultrasound for 1 minute. In a second glass beaker 1.0 g of Texapon in 15% form (Cognis, Germany) and 80 g of water are mixed by shaking. The solution from the first glass beaker is introduced into the second and the combined solution is ultrasonicated with ice cooling for 7 minutes. As an initiator, 0.22 g of tert-butyl per-2-ethylhexanoate is introduced, and the solution is poured into a round-bottomed flask and heated at 80° C. The polymerization time is approximately 3 hours.

### Example 3

In a glass beaker 7.49 g of methyl methacrylate, 7.43 g of butyl methacrylate, 0.09 g of 2-methacryloyloxyethyl phosphate, 0.6 g of hexadecane and 1.5 g of MagSilica (SiO₂/Fe₂O₃) are homogenized using an Ultraturrax for 1 minute and then homogenized with ultrasound for 1 minute. In a second glass beaker 5.0 g of Texapon in 15% form (Cognis, Germany) and 80 g of water are mixed by shaking. The solution from the first glass beaker is introduced into the second and the combined solution is ultrasonicated with ice cooling for 7 minutes. As an initiator, 0.22 g of tert-butyl per-2-ethylhexanoate is introduced, and the solution is poured into a round-bottomed flask and heated at 80° C. The polymerization time is approximately 3 hours.

### Example 4

In a glass beaker 7.43 g of methyl methacrylate, 7.13 g of butyl methacrylate, 0.45 g of 2-methacryloyloxyethyl phosphate, 0.6 g of hexadecane and 1.5 g of MagSilica (SiO₂/Fe₂O₃) are homogenized using an Ultraturrax for 1 minute and then homogenized with ultrasound for 1 minute. In a second glass beaker 5.0 g of Texapon in 15% form (Cognis, Germany) and 80 g of water are mixed by shaking. The solution from the first glass beaker is introduced into the second and the combined solution is ultrasonicated with ice cooling for 7 minutes. As an initiator, 0.22 g of tert-butyl per-2-ethylhexanoate is introduced, and the solution is poured into a round-bottomed flask and heated at 80° C. The polymerization time is approximately 3 hours.

### Example 5

In a glass beaker 7.5 g of methyl methacrylate, 7.5 g of butyl methacrylate, 0.6 g of hexadecane and 1.5 g of MagSilica (SiO₂/Fe₂O₃) are homogenized using an Ultraturrax for 1 minute and then homogenized with ultrasound for 1 minute. In a second glass beaker 5.0 g of Texapon in 15% form (Cognis, Germany) and 80 g of water are mixed by shaking. The solution from the first glass beaker is introduced into the second and the combined solution is ultrasonicated with ice cooling for 7 minutes. As an initiator, 0.22 g of tert-butyl per-2-ethylhexanoate is introduced, and the solution is poured into a round-bottomed flask and heated at 80° C. The polymerization time is approximately 3 hours.

### Example 6

In a glass beaker 7.13 g of methyl methacrylate, 7.13 g of butyl methacrylate, 0.75 g of 2-dimethylaminoethyl methacrylate, 0.6 g of hexadecane and 1.5 g of MagSilica (SiO₂/Fe₂O₃) are homogenized using an Ultraturrax for 1 minute and then homogenized with ultrasound for 1 minute. In a second glass beaker 5.0 g of Texapon in 15% form (Cognis, Germany) and 80 g of water are mixed by shaking. The solution from the first glass beaker is introduced into the second and the combined solution is ultrasonicated with ice cooling for 7 minutes. As an initiator, 0.22 g of tert-butyl per-2-ethylhexanoate is introduced, and the solution is poured into a round-bottomed flask and heated at 80° C. The polymerization time is approximately 3 hours.

1: Hybrid material comprising nanoscale superparamagnetic, ferromagnetic, ferrimagnetic or paramagnetic particles enveloped by polymers.

2: Hybrid material according to claim 1, characterized in that nanoscale superparamagnetic, ferromagnetic, ferrimagnetic or paramagnetic particles are enveloped by poly(meth)acrylates.

3: Hybrid material according to claim 1, characterized in that the enveloping polymers possess a single-layer or multilayer construction.

4: Hybrid material according to claim 1, characterized in that the core comprises nanoscale superparamagnetic, ferromagnetic, ferrimagnetic or paramagnetic particles from the group of the ferrites.

5: Hybrid material according to claim 4, characterized in that the core comprises nanoscale superparamagnetic, ferromagnetic, ferrimagnetic or paramagnetic particles from the group of the ferrites enveloped by silicon oxides.

6: Hybrid material according to claim 4, characterized in that the core comprises nanoscale superparamagnetic, ferromagnetic, ferrimagnetic or paramagnetic particles from the group of the iron oxides enveloped by silicon oxides.

7: Hybrid material according to claim 1, characterized in that the first shell comprises polymers which are gellable in plasticizers or in plasticizer-containing adhesives or in epoxy adhesives.

8: Hybrid material according to claim 1, characterized in that the first shell comprises polymers or polymer blends which at elevated temperature enter into crosslinking reactions with plasticizers.

9: Hybrid material according to claim 1, characterized in that the polymers in the first shell are composed of one or more monomers from the group of the (meth)acrylates and imidazoles.

10: Hybrid material according to claim 9, characterized in that the polymers in the first shell comprise vinylimidazole.

11: Hybrid material according to claim 1, characterized in that further auxiliaries and additives are present.

12: Hybrid material according to claim 1, characterized in that emulsifiers and hydrophobic agents are present.

13: Hybrid material according to claim 1, characterized in that the outer shell or shells is/are composed of polymers or polymer blends which are not gellable in the matrix at room temperature and of polymers or polymer blends which are gellable in the matrix at elevated temperature.

14: Hybrid material according to claim 13, characterized in that the outer shell or shells is/are composed of mixtures of polymethyl methacrylate and vinylimidazole.

15: Hybrid material according to claim 13, characterized in that the outer shell or shells is/are composed of polymethyl methacrylate.

16: Method of producing hybrid materials according to claim 1 by miniemulsion polymerization.

17: Method of producing hybrid materials according to claim 1, characterized in that a) the nanoscale powder is dispersed in the monomers or monomer mixtures or in water, b) monomers or monomer mixtures with hydrophobic agents, emulsifiers and water is dispersed, c) the dispersions from a) and b) are dispersed and d) subsequently polymerized.

18: Method of producing hybrid materials according to claim 17, characterized in that c), the dispersions a) and b) are dispersed by means of ultrasound, membrane, high pressure, rotor/stator system and/or stirring.

19: The method of using hybrid materials according to claim 1 in adhesives.

20: The method of using hybrid materials according to claim 1 as one-component adhesive.

21: The method of using hybrid materials according to claim 1 in an adhesive matrix as 2 stage adhesive.

22: The method of using hybrid materials according to claim 21 in an epoxy matrix as 2 stage adhesive.

23: The method of using adhesives according to claim 19 in automotive construction, aircraft construction, shipbuilding, rail-vehicle construction and space-travel technology.
